(19) United States
(12) Patent Application Publication
(10) Pub. No.: US 2022/0383309 A1
(43) Pub. Date: Dec. 1, 2022

(54) AUTHORIZATION DEVICE

(71) Applicant: NTT DOCOMO, INC., Chiyoda-ku (JP)

(72) Inventors: Hiroyuki HAKODA, Chiyoda-ku (JP); Yoshiki SAWAKAMI, Chiyoda-ku (JP)

(73) Assignee: NTT DOCOMO, INC., Chiyoda-ku (JP)

(21) Appl. No.: 17/773,976

(22) PCT Filed: Oct. 7, 2020
(86) PCT No.: PCT/JP2020/038008

§ 371 Date: May 3, 2022

(30) Foreign Application Priority Data
Nov. 19, 2019 (JP) 2019-208784

(51) Int. Cl. G06Q 20/40

(52) U.S. Cl. CPC G06Q 20/40; G06Q 20/32

(57) ABSTRACT

An object of the present invention is to provide an authorization device that enables payment approval processing according to a location of a user terminal without need for a positioning function. In an authorization server 100, a location based authorization determination unit 102 acquires, from a location information DB 400, location information based on location registration of a communication terminal 300 being a user terminal, and determines whether a location relationship between location information of the communication terminal 300 when a user makes a payment and an affiliated store 200 where the user makes the payment satisfies a predetermined condition (e.g., the location relationship is within a predetermined distance). When it is determined that the predetermined condition is satisfied, the payment by the user of the communication terminal 300 is allowed.

### TECHNICAL FIELD

The present invention relates to an authorization device that approves a user payment.

### BACKGROUND ART

According to the invention described in Patent Literature 1, a credit card for use and a mobile terminal are associated in advance, and when a user makes a credit card payment, an authentication server authenticates that the location of the registered mobile terminal matches the place of use.

### CITATION LIST

### Patent Literature

PTL1: Japanese Unexamined Patent Publication No. 2005-216210

### SUMMARY OF INVENTION

### Technical Problem

In the technique described in Patent Literature 1, however, a mobile terminal needs to have a positioning function such as GPS.

To solve the above problem, an object of the present invention is to provide an authorization device that enables payment approval processing according to a location of a user terminal such as a mobile terminal without need for a positioning function.

### Solution to Problem

An authorization device according to the present invention includes an acquisition unit configured to acquire location information based on location registration of a user terminal, a determination unit configured to determine whether a location relationship between location information of the user terminal when a user makes a payment and a store where the user makes the payment satisfies a predetermined condition, and a payment control unit configured to determine legitimacy of the payment by the user of the user terminal.

According to the present invention, it is capable of finding a location of a user terminal by using location information based on location registration with a network without using a positioning means such as GPS, and thereby determining the legitimacy of a payment by a user on the basis of this location.

### Advantageous Effects of Invention

According to the present invention, it is capable of determining the legitimacy of a payment by a user by using location information based on location registration with a network without using a positioning means such as GPS.

### BRIEF DESCRIPTION OF DRAWINGS

FIG. 1 is a block diagram showing a system configuration of an authorization server 100 according to a first embodiment;

FIG. 2 is a flowchart showing an operation of the authorization server 100;

FIG. 3 is a block diagram showing a system configuration of an authorization server 100a according to an alternative example;

FIG. 4 is a block diagram showing a system configuration of an authorization server 100b according to a second embodiment;

FIG. 5 is a schematic view showing a cover area of a base station, a location of a communication terminal 300, a threshold, and an affiliated store;

FIG. 6 is a flowchart showing an operation of the authorization server 100b;

FIG. 7 is a block diagram showing a system configuration of an authorization server 100c according to an alternative example;

FIG. 8 is a schematic view showing a cover area of a base station, a location of a communication terminal 300, and an affiliated store;

FIG. 9 is a flowchart showing an operation of an authorization server 100c; and

FIG. 10 is a view showing an example of a hardware configuration of an authorization server 100 according to one embodiment of the present disclosure.

### DESCRIPTION OF EMBODIMENTS

Embodiments of the present invention are described hereinafter with reference to the attached drawings. Note that, where possible, the same elements are denoted by the same reference symbols and redundant description thereof is omitted.

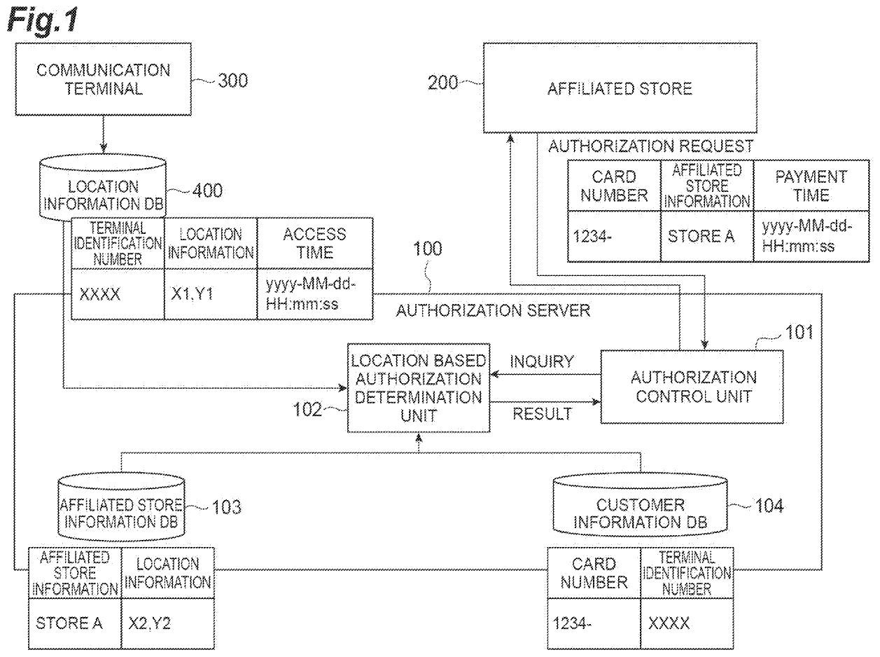

FIG. 1 is a view showing a system configuration of an authorization server 100 according to a first embodiment (which is referred to hereinafter as the authorization server 100). As shown in FIG. 1, when the authorization server 100 receives an authorization request based on a credit card payment from an affiliated store 200, the authorization server 100 acquires location information of a communication terminal 300 associated with this authorization request from a location information DB 400, and determines the legitimacy of the credit card payment on the basis of a location relationship using this location information. Note that, as a premise, when a payment is made with a credit card, this credit card payment is determined to be legitimate if the communication terminal 300 is possessed by its user.

The location information DB 400 is a database that stores location information which the communication terminal 300 has registered with a mobile communication network, and it is information based on location registration that is typically used in a mobile phone or the like. This location information is a location (coordinates) of a base station or a location (coordinates; the center of gravity of a sector etc.) based on a communication area of a base station. The authorization server 100 includes an authorization control unit 101 (output unit), a location based authorization determination unit 102 (determination unit), an affiliated store information DB 103, and a customer information DB 104.

The authorization control unit 101 is a part that receives an authorization request from the affiliated store 200 and then makes an inquiry to the location based authorization determination unit 102, and transmits a result to the affiliated store 200. Note that the affiliated store 200 includes a credit card payment terminal, and this payment terminal transmits an authorization request to the authorization server 100 when making a payment transaction at the time of a credit card payment. This authorization request contains a card number of a credit card, affiliated store information, and payment time.

The location based authorization determination unit 102 is a part that determines whether a payment with a credit card by a user is legitimate or not on the basis of location information of the user and location information of an affiliated store where the payment is made.

A specific process is as follows. When the location based authorization determination unit 102 receives an inquiry from the authorization control unit 101, it refers to the customer information DB 104 and acquires a terminal identification number by using the card number contained in the authorization request as a key. The location based authorization determination unit 102 then refers to the location information DB 400 and acquires location information corresponding to the terminal identification number. Then, the location based authorization determination unit 102 refers to the affiliated store information DB 103 and acquires location information of the affiliated store on the basis of the affiliated store information contained in the authorization request.

The location based authorization determination unit 102 determines whether the affiliated store and the communication terminal 300 have a predetermined location relationship by using the location information of the affiliated store and the location information of the communication terminal 300. For example, the location based authorization determination unit 102 determines whether their locations are within a predetermined range. When the location based authorization determination unit 102 determines that their locations are within a predetermined range, it transmits, to the authorization control unit 101, a result indicating that the payment transaction with the credit card is legitimate. When, on the other hand, the location based authorization determination unit 102 determines that their locations are outside a predetermined range, it transmits, to the authorization control unit 101, a result indicating that the payment transaction with the credit card is not legitimate.

In the above description, the location based authorization determination unit 102 may make a determination about the legitimacy of a payment with a credit card on condition that the payment time when a user makes a payment transaction and the time of location information of the communication terminal 300 are within a predetermined time.

The affiliated store information DB 103 is a database that stores affiliated store information and its location information (coordinates). Although the affiliated store information is a store name in this example, it is not limited thereto, and identification information that identifies an affiliated store may be used instead. Alternatively, identification information of a payment terminal located in an affiliated store may be used. Further, the location information is coordinate information in this example, and it is information preset by a setter on the basis of the location of a store.

The customer information DB 104 is a database that stores a card number of a credit card and a terminal identification number. It is a database for identifying a terminal identification number of the communication terminal 300 owned by a customer who is a credit card holder.

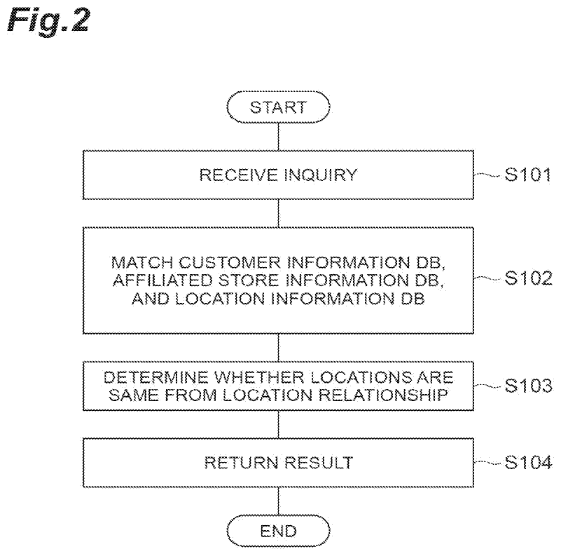

FIG. 2 is a flowchart showing an operation of the location based authorization determination unit 102 in the authorization server 100. As shown in FIG. 2, when the location based authorization determination unit 102 receives an inquiry from the authorization control unit 101 (S101), it refers to the information by referring to the customer information DB 104, the affiliated store information DB 103, and the location information DB 400 to match information (S102).

The location based authorization determination unit 102 determines the legitimacy of a payment on the basis of whether the communication terminal 300 and an affiliated store are in the same place (within a predetermined distance) from the location relationship between the location information of the communication terminal 300 and the location information of the affiliated store, (S103), and transmits a determination result to the authorization control unit 101 (S104). Note that the location based authorization determination unit 102 may derive the probability of fraud payment in accordance with this distance. For example, the location based authorization determination unit 102 derives the probability in such a way that the probability of fraud increases as the distance is longer. For example, a mathematical expression with a correlation between the distance and the probability of fraud payment is used. The authorization control unit 101 or an authorization comprehensive determination unit (which is not shown in FIG. 1) may determine the legitimacy of a payment on the basis of this probability.

The authorization control unit 101 transmits a determination result of the location based authorization determination unit 102 to the affiliated store 200, and the affiliated store 200 determines whether or not to allow the credit card payment according to this result.

In this manner, a determination about the legitimacy of a payment with a credit card can be made on the basis of the location of use of the credit card and the location information of the communication terminal 300. Note that, although the legitimacy of a payment with a credit card is determined in the first embodiment and a second embodiment described later, the present invention is not limited thereto. The authorization server 100 is applicable also to an electronic payment means using FeliCa (registered trademark) electronic money for prepaid charging or an electronic payment means using a QR code.

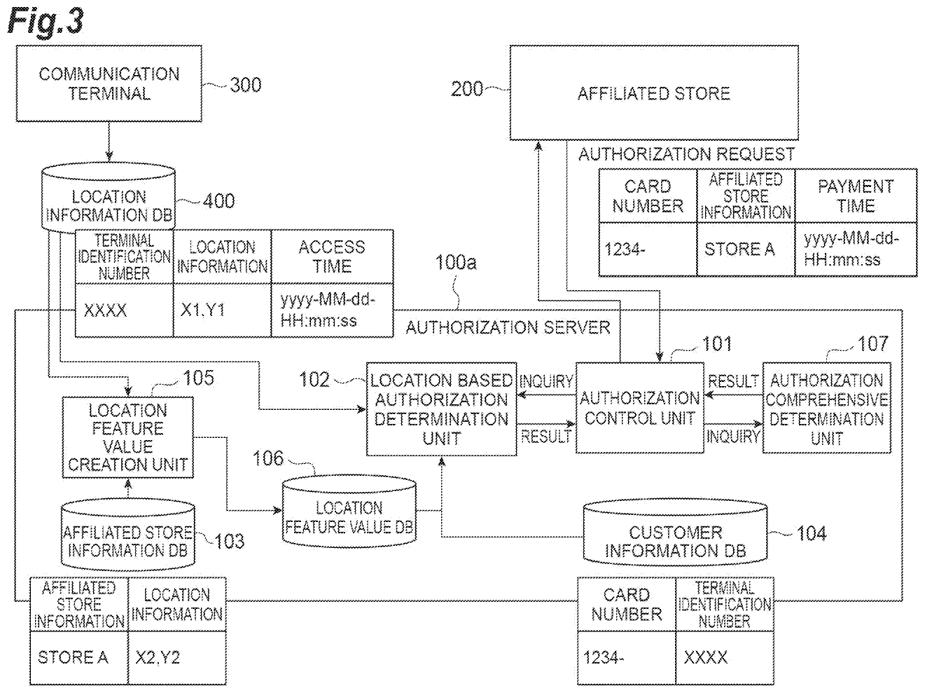

An authorization server 100a, which is an alternative example of the authorization server 100 according to the first embodiment, is described hereinafter with reference to FIG. 3. FIG. 3 is a block diagram showing a system configuration of the authorization server 100a. The authorization server 100a in this alternative example is different from the authorization server 100 in that it includes a location feature value creation unit 105, a location feature value DB 106, and an authorization comprehensive determination unit 107.

The location feature value creation unit 105 is a part that creates a location feature value on the basis of information stored in the location information DB 400 and the affiliated store information DB 103. Specifically, the location feature value creation unit 105 creates information indicating a feature of the location of the communication terminal 300 on the basis of the past location information in the location information DB 400. Further, the location feature value creation unit 105 creates information indicating in what place an affiliated store is located on the basis of the location information of the affiliated store information DB 103.

For example, the location feature value creation unit 105 derives a difference or a match or mismatch between the coordinates of user's home or workplace registered in advance and the location of the communication terminal 300, and uses it as a feature value. Further, the location feature value creation unit 105 determines whether the communication terminal 300 or the affiliated store 200 is located in a high theft area by referring to theft frequency map information (not shown), and creates information indicating that or a difference from this area (or location) as a location feature value. Further, the location feature value creation unit 105 may acquire the frequency of staying in a high theft area on the basis of the location information of the communication terminal 300 and create this frequency as a location feature value.

The above-described feature value is information to be used as a reference for calculating the probability of fraud payment (or legitimate payment), and it may serves as an explanatory variable.

The location feature value is not limited to the above example, and it may be based on a data source different from a location, such as time information like a high theft time, for example. Further, the location feature value creation unit 105 is not always necessary, and the location based authorization determination unit 102 or another acquisition unit (not shown) may acquire information corresponding to the location feature value generated by external processing such as an external server and use this acquired information.

The location feature value DB 106 is a database that stores location feature values.

The location based authorization determination unit 102 determines the location relationship between the communication terminal 300 and the affiliated store 200 on the basis of the location feature value DB 106 and the customer information DB 104.

Further, in the case where the communication terminal 300 and the affiliated store 200 have a predetermined location relationship (e.g., they are within a predetermined distance), the location based authorization determination unit 102 refers to the location feature value DB 106, and when the frequency that the communication terminal 300 is located in a high theft area is a predetermined value or more and the affiliated store 200 is located in a high theft area, it calculates the probability that the payment with the credit card is not legitimate. Specifically, the location based authorization determination unit 102 calculates the probability of fraud payment on the basis of the feature value of the communication terminal 300 and/or the affiliated store 200. This probability increases according to the frequency or time that the communication terminal 300 is located in a high theft area. For example, the probability is 20% when the frequency is 10 times per week or less, and the probability is 30% when the frequency is 20 times per week. Further, this probability increases according to the level of theft in the high theft area where the communication terminal 300 and the affiliated store 200 are located. The level of theft is registered in a theft frequency map.

The location based authorization determination unit 102 transmits this probability to the authorization comprehensive determination unit 107 and thereby makes an inquiry. Note that the location based authorization determination unit 102 may use the location feature value of any one of the communication terminal 300 and the affiliated store 200.

The authorization control unit 101 receives this determination result and transmits it to the affiliated store 200.

The authorization comprehensive determination unit 107 determines the legitimacy of the payment according to the probability transmitted from the location based authorization determination unit 102. For example, the authorization control unit 101 determines that this payment is legitimate when the probability is 20% or less.

An authorization server 100b according to a second embodiment is described hereinafter. When the authorization server 100b makes a determination about the legitimacy of a credit card payment by using location information based on location registration, the determination is made on the basis of an area covered by a base station. Since the size of an area covered by a base station generally depends on the beam direction, beam shape, and beam intensity of the base station, some regions have a small area and other regions have a large area. In general, the beam direction and the like of a base station are set in such a way that the area is small in urban regions and the area is large in local regions. Thus, if a criterion for determination is set to be the same for all areas, a determination about the legitimacy or fraud of a credit card payment can be wrong.

The authorization server 100b according to the second embodiment determines a location relationship between the communication terminal 300 and the affiliated store 200 in consideration of the size of an area covered by a base station and the like.

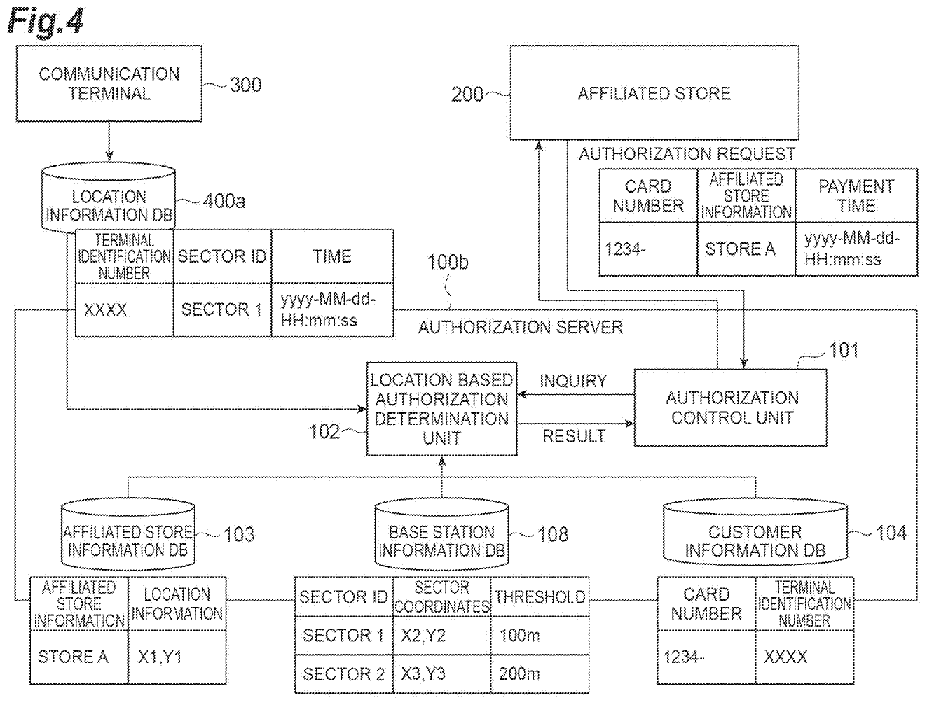

FIG. 4 is a block diagram showing a system configuration of the authorization server 100b according to the second embodiment. This authorization server 100b is different from the authorization server 100 in that it further includes a base station information DB 108. Further, information stored in a location information DB 400a is different.

The base station information DB 108 stores a sector ID indicating a sector covered by a base station, coordinates indicating this sector, and a threshold for determining a location relationship between the communication terminal 300 and an affiliated store. The coordinates indicating a sector are typically barycentric coordinates of a sector. The range of a sector may be stored in place of the coordinates.

The location information DB 400a stores a terminal identification number of the communication terminal 300, a sector (area covered by a base station) where the communication terminal 300 is located, and access time.

The location based authorization determination unit 102 extracts a sector ID where the communication terminal 300 is located by referring to the location information DB 400, and extracts sector coordinates from the base station information DB 108 by using this sector ID as a key. Then, the location based authorization determination unit 102 determines whether the sector coordinates (the base station information DB 108) and the coordinates of the affiliated store (the affiliated store information DB 103) are within a range indicated by the threshold (the base station information DB 108), and thereby determines the legitimacy of a credit card payment.

Instead of the above-described determination about a payment, the probability of legitimate payment or fraud payment may be derived as described earlier. A derivation method derives the probability in such a way that the probability of fraud payment increases as a difference between an actual distance and a threshold increases. Note that, as described in the first embodiment, a determination may be made about the legitimacy of a payment different from a credit card payment.

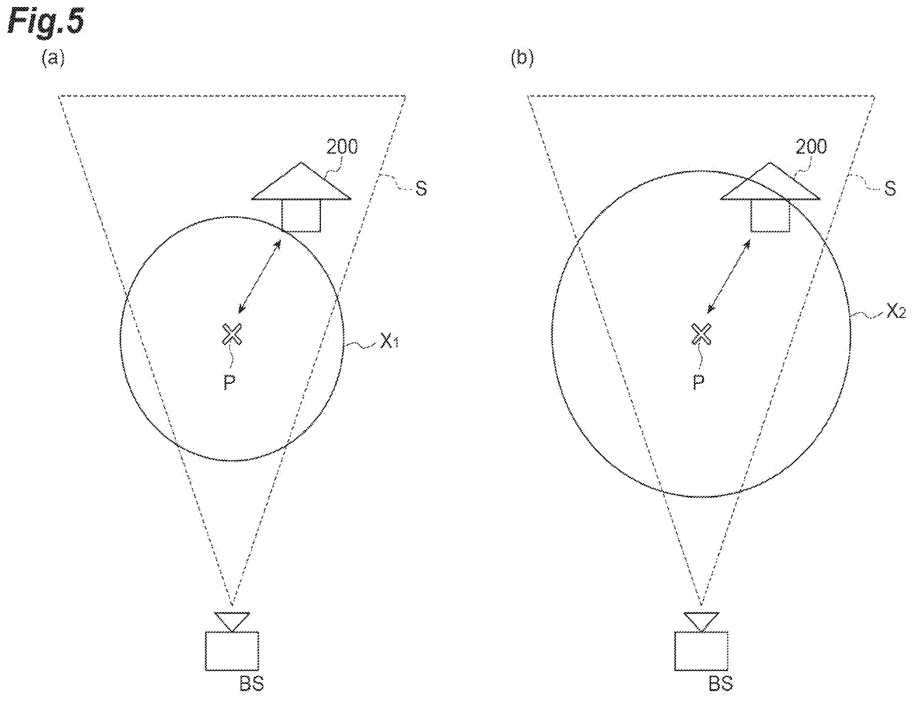

FIG. 5 is a schematic view showing a cover area of a base station, a location of the communication terminal 300, a threshold, and an affiliated store. In FIG. 5(a), a base station BS forms a sector S, which is a cover area, with a directional beam. A location P indicates a general location of the communication terminal 300 that has made location registration with the base station BS. This is typically the barycentric location of the sector S. In the second embodiment, a location of the communication terminal 300 is a location based on a base station or its sector. A range X1 is a range defined by a threshold, and it is formed on the basis of the threshold associated with the base station BS as described earlier. The same applies to FIG. 5(b).

In FIG. 5(a), the affiliated store 200 is outside the range X1 that is defined on the basis of the location P of the communication terminal 300 and the threshold. When the communication terminal 300 and the affiliated store 200 have such a location relationship, this credit card payment is determined to be fraud.

In FIG. 5(b), the affiliated store 200 is inside a range X2 that is defined on the basis of the location P of the communication terminal 300 and the threshold. When the communication terminal 300 and the affiliated store 200 have such a location relationship, this credit card payment is determined to be legitimate.

In this manner, since the range X varies depending on the threshold, even when the distance between the communication terminal 300 and the affiliated store 200 is the same, the threshold to serve as a criterion for determination varies depending on an area where the communication terminal 300 is located, and a determination result about the legitimacy of a payment with a credit card varies accordingly.

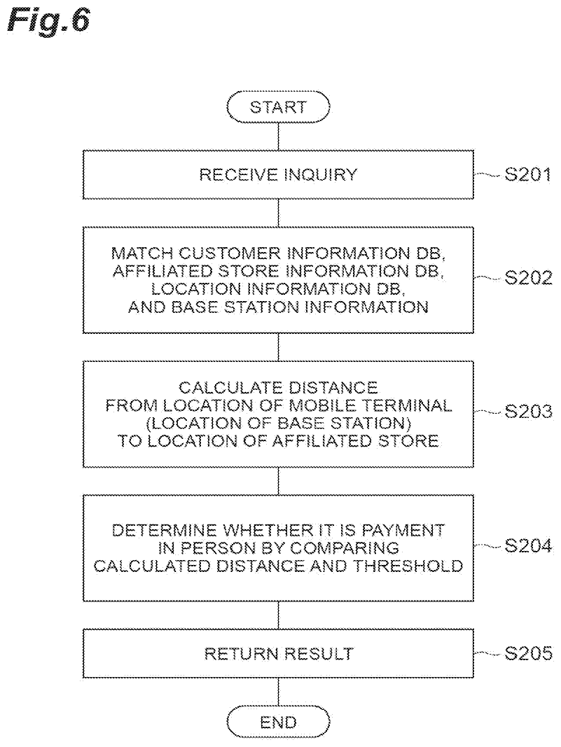

FIG. 6 is a flowchart showing an operation of the authorization server 100b. The location based authorization determination unit 102 receives an inquiry from the authorization control unit 101 that has received an authentication request (S201).

Receiving an inquiry, the location based authorization determination unit 102 matches the customer information DB 104, the affiliated store information DB 103, the base station information DB 108, and the location information DB 400 (S202). Specifically, the location based authorization determination unit 102 identifies the communication terminal 300 from the customer information DB 104 by using the card number contained in the authentication request as a key, and acquires base station information where the communication terminal 300 is located from the location information DB 400. Then, the location based authorization determination unit 102 acquires the coordinates of this base station and the threshold by referring to the base station information DB 108.

Further, by using an affiliated store indicated by the affiliated store information contained in the authentication request as a key, the location based authorization determination unit 102 acquires its location information from the affiliated store information DB 103.

Then, the location based authorization determination unit 102 calculates the distance between the location information of the communication terminal 300 and the location information of the affiliated store (S203).

The location based authorization determination unit 102 determines whether it is a credit card payment made by the identical person or not on the basis of the calculated distance and the threshold (S204). Specifically, when the distance between the affiliated store and the communication terminal 300 is within the threshold, the location based authorization determination unit 102 determines that this credit card payment is legitimate, and when the distance is outside the threshold, it determines that this credit card payment is fraud.

The location based authorization determination unit 102 returns this result to the authorization control unit 101 (S205). The authorization control unit 101 further transmits this result to the affiliated store 200 as a response to the authorization request.

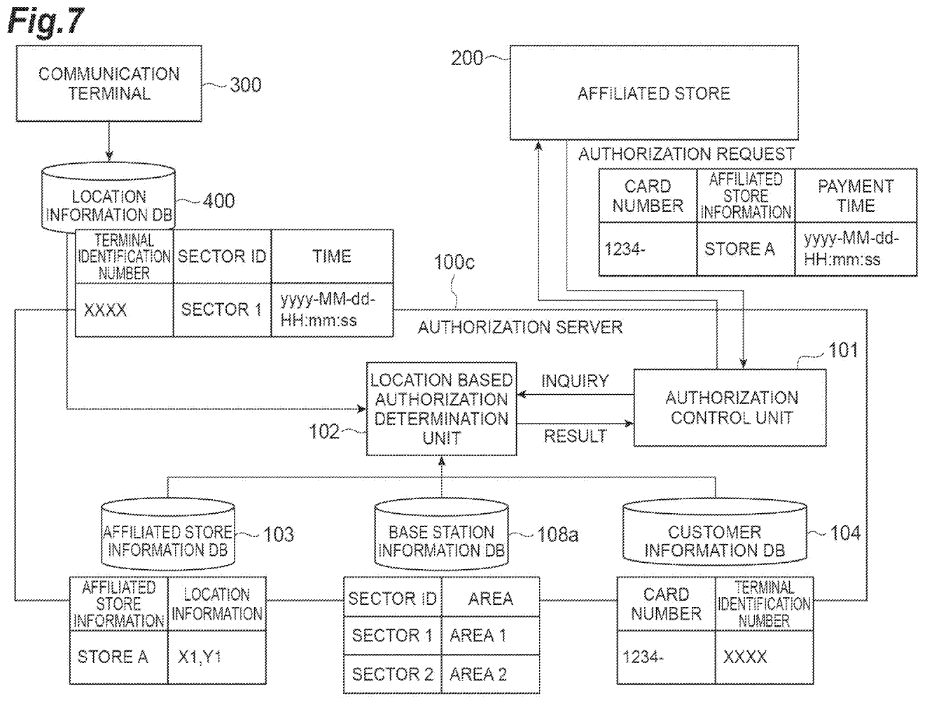

An alternative example of the second embodiment is described hereinafter. FIG. 7 is a block diagram showing a system configuration of an authorization server 100c according to an alternative example. The authorization server 100c is different from the authorization server 100b in that it includes a base station information DB 108a.

The base station information DB 108a stores a legitimate payment area in association with each sector formed by a base station. Specifically, the size of an area determined as a legitimate payment is defined for each sector. The size of this area is varied for each sector, and it is set to an appropriate size by an administrator of this system on the basis of the characteristics of the sector (beam direction, beam intensity, beam shape etc.). Further, the size may be set on the basis of the frequency of theft or the like. Thus, all sectors do not necessarily represent the same area. Although a legitimate payment area is specified by information of a plurality of coordinates forming a polygonal shape, it is not limited thereto.

The location based authorization determination unit 102 refers to the base station information DB 108a and thereby acquires the sector ID corresponding to the base station where the communication terminal 300 is located. The location based authorization determination unit 102 then refers to the base station information DB 108 by using this sector ID as a key and thereby acquires its area (information indicating the range of the sector). When the location of the affiliated store obtained by referring to the affiliated store information DB is included in this area, the location based authorization determination unit 102 determines that this credit card payment is legitimate.

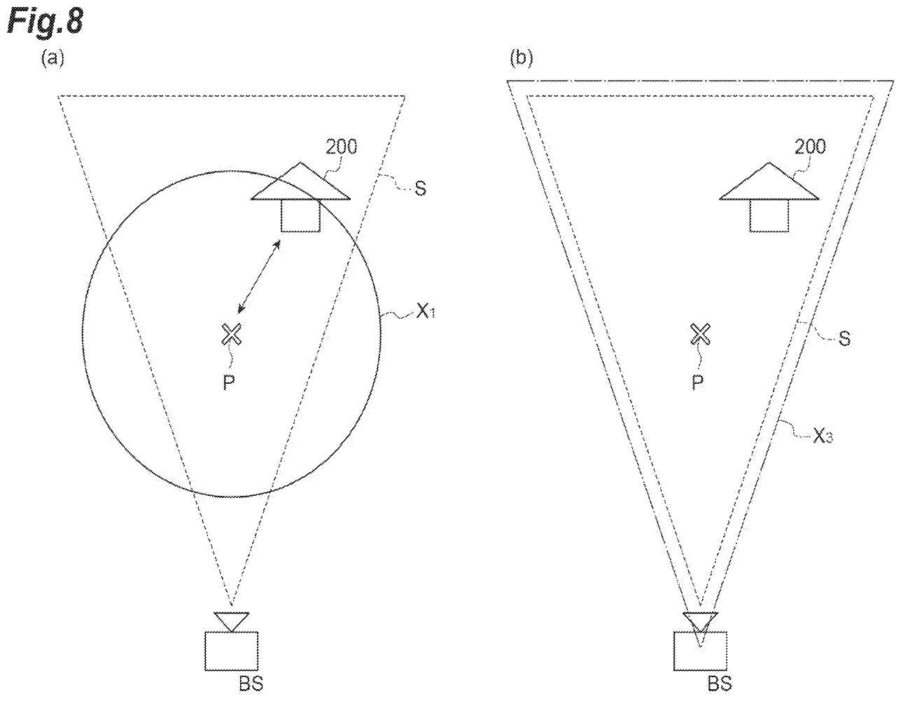

FIG. 8 is a schematic view thereof. FIG. 8(a) is a schematic view in the above-described second embodiment, and it is a schematic view of the case where a range X1 is defined on the basis of a threshold, and the legitimacy of a payment with a credit card in the affiliated store 200 is determined on the basis of the range X1. FIG. 8(b) is a schematic view showing an area X3 where a payment is determined as legitimate payment.

As shown in FIG. 8(b), the area X3 is set to cover the whole of a sector S. In this case, the communication terminal 300 is located in the sector S, and when a credit card payment transaction is performed, this payment is determined to be legitimate. Note that this area X3 is a range that is set in advance. Although the area X3 is set to cover the whole of the sector S, it is not limited thereto. It may be set to cover a part of the sector S. This area X3 is set arbitrarily by the beam direction, beam shape, and beam intensity of a base station.

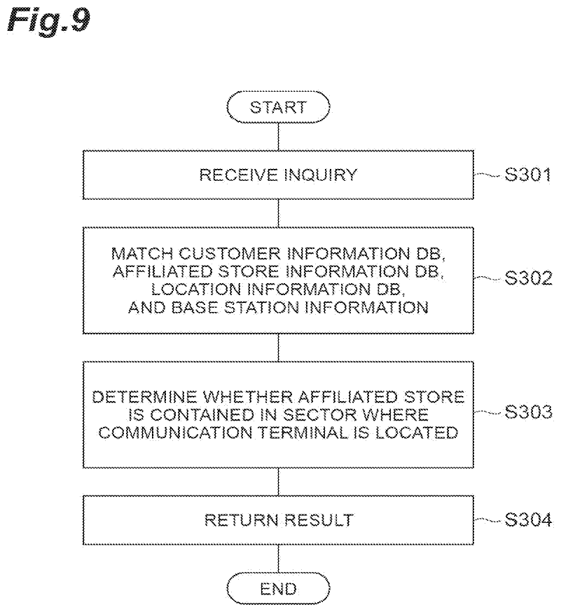

FIG. 9 is a flowchart showing an operation of the location based authorization determination unit 102 in the authorization server 100c. When the location based authorization determination unit 102 receives an inquiry from the authorization control unit 101 (S301), it matches the customer information DB 104, the affiliated store information DB 103, the base station information DB 108, and the location information DB 400, and thereby identifies a sector where the communication terminal 300 is located (S302).

Then, the location based authorization determination unit 102 determines the legitimacy of the payment on the basis of whether the affiliated store is included in the sector (the area covered by the base station) where the communication terminal 300 is located (S303). The location based authorization determination unit 102 transmits a determination result to the authorization control unit 101 (S304). The authorization control unit 101 acquires a determination result about the legitimacy of a credit card payment and transmits it to the affiliated store 200.

Although the legitimacy of a payment with a credit card is determined on the basis of whether the affiliated store 200 is located in the area of the sector where the communication terminal 300 is located, it is not limited thereto.

For example, the location information DB 400 stores the barycentric coordinates of a sector where the communication terminal 300 is located, and the affiliated store information DB 103 stores a predetermined range of area associated with the affiliated store 200. The location based authorization determination unit 102 may determine the legitimacy of a payment on the basis of whether the communication terminal 300 is located in the area of the affiliated store 200. Note that the area of the affiliated store 200 may be appropriately set by a setter, or a sector of a base station geographically close to the affiliated store 200 may be set as the area.

Further, location information in the location information DB 400 and the affiliated store information DB 103 may be a predetermined range of area rather than coordinates. The location information DB 400 may store a sector ID where the communication terminal 300 is located, and the affiliated store information DB 103 may store a sector ID of a predetermined area or a base station geographically close to the affiliated store 200.

The location based authorization determination unit 102 may make a determination on the basis of a part where an area with a sector ID where the communication terminal 300 is located and an area or an area with the sector ID that is associated with an affiliated store overlap. Specifically, when the overlapping part is a predetermined range or more, the location based authorization determination unit 102 determines that it is not fraud use, and when the overlapping part is less than the predetermined range, the location based authorization determination unit 102 determines that it is fraud use.

Further, the location based authorization determination unit 102 may derive the probability of fraud payment in accordance with the size of the overlapping part. The location based authorization determination unit 102 calculates the probability of fraud payment in such a way that it decreases as the size of the overlapping part is larger.

The location based authorization determination unit 102 may transmit the calculated probability to the authorization control unit 101 and the authorization comprehensive determination unit (not shown in FIG. 7) and make a determination about fraud payment based on this probability.

By using the overlapping range, a determination about fraud payment can be made without using the distance or the coordinates.

The operational advantages of the authorization server 100 to the authorization server 100c according to the first embodiment and the second embodiment are described hereinbelow.

The authorization server 100 according to the first embodiment includes the customer information DB 104 that stores a credit card (card number), which is a payment means, and the communication terminal 300 (terminal identification number) in association with each other. The location based authorization determination unit 102 acquires location information based on location registration of the communication terminal 300 when a payment with a credit card is made. The location based authorization determination unit 102 then determines the legitimacy of the credit card payment on the basis of whether the location relationship between this location information and the affiliated store 200 where the credit card payment is made satisfies a predetermined condition or not. The location based authorization determination unit 102 outputs a determination result about the legitimacy of the payment to the authorization control unit 101. The authorization control unit 101 transmits the determination result to the affiliated store 200 in response to an authorization request.

Further, when the location relationship satisfies a predetermined condition (for example, the distance between the communication terminal 300 and the affiliated store 200 is within a predetermined value), the location based authorization determination unit 102 determines that the credit card payment is legitimate, and when the location relationship does not satisfy the predetermined condition, the location based authorization determination unit 102 determines that the credit card payment is not legitimate.

This allows finding the location of the communication terminal 300 by using location information based on location registration with a network without using a positioning means such as GPS and thereby determining the legitimacy of a credit card payment based on the location. A determination about the legitimacy of a credit card payment is thereby achieved with a simple configuration.

Further, as described earlier, the location based authorization determination unit 102 may calculate the probability indicating the legitimacy of a payment on the basis of the location relationship between the communication terminal 300 and the affiliated store 200, and the authorization control unit 101 or the authorization comprehensive determination unit may determine the legitimacy of a payment on the basis of this probability.

The location based authorization determination unit 102 thereby calculates the probability, so that another determination unit (the authorization control unit 101 or the authorization comprehensive determination unit) comprehensively determines fraud payment in consideration of another requirement.

Further, in the authorization server 100a according to an alternative example, the location feature value creation unit 105 functions as a terminal feature value generation unit and acquires the past location information of the communication terminal 300 from the location information DB 400 and then creates a location feature value of the communication terminal 300 from the past location information. Likewise, the location feature value creation unit 105 functions as a store feature value generation unit, and creates a location feature value of an affiliated store by referring to the affiliated store information DB 103. Those location feature values represent the features of areas where the communication terminal 300 and the affiliated store 200 are located.

Then, even when the location relationship between the communication terminal 300 and the affiliated store 200 satisfies a predetermined condition, the location based authorization determination unit 102 further determines the legitimacy of a credit card payment on the basis of the location feature values.

The authorization server 100a is thereby able to determine the legitimacy of a credit card payment according to a location history of the communication terminal 300 and a place where the affiliated store 200 is located. Thus, even when a location where a payment is made and a location where a user is located are within a predetermined range, if this location is a high theft area or the like, this payment is determined not to be legitimate, which prevents fraud use.

Further, in the authorization server 100b, the location based authorization determination unit 102 determines whether a predetermined condition is satisfied or not on the basis of the relationship between the distance between a location based on location registration of the communication terminal 300 and a location of the affiliated store 200 and a threshold. For example, the location based authorization determination unit 102 determines whether this distance is within the threshold or not.

This allows determining the legitimacy of a credit card payment according to this distance.

Further, by setting the threshold according to the characteristics of an area covered by a base station with which the communication terminal 300 has made location registration, a determination can be made according to the characteristics, such as the size, of the area covered by the base station. Since the size of an area covered by a base station generally depends on the beam direction, beam shape, and beam intensity of the base station, some regions have a small area and other regions have a large area. Thus, if a determination is made on the basis of a uniform threshold, it can lead to a wrong determination.

Further, the authorization server 100 further includes the base station information DB 108, which is a base station information storage unit that stores location information of a base station, and the customer information DB 104, which is a customer information storage unit containing a credit card number that is information for specifying the communication terminal 300 and a payment. The location based authorization determination unit 102 determines the legitimacy of a payment by referring to the affiliated store information DB 103, the base station information DB 108, and the customer information DB 104.

This allows various information to be obtained in advance and thereby enables an accurate determination.

Further, in the authorization server 100c, the location based authorization determination unit 102 determines whether a predetermined condition is satisfied or not on the basis of whether the affiliated store 200 is located in an area based on a base station with which the communication terminal 300 has made location registration. Specifically, when the affiliated store 200 is located in a predetermined range that is a legitimate payment area associated in the base station information DB 108a, the location based authorization determination unit 102 determines that a credit card payment is legitimate.

Thus, when the affiliated store 200 is located in a legitimate payment area that is set according to an area covered by a base station with which the communication terminal 300 has made location registration, it is determined that a payment with a credit card is legitimate, which prevents fraud use of the credit card.

The block diagram used for the description of the above embodiments shows blocks of functions. Those functional blocks (component parts) are implemented by any combination of at least one of hardware and software. Further, a means of implementing each functional block is not particularly limited. Specifically, each functional block may be implemented by one physically or logically combined device or may be implemented by two or more physically or logically separated devices that are directly or indirectly connected (e.g., by using wired or wireless connection etc.). The functional blocks may be implemented by combining software with the above-described one device or the above-described plurality of devices.

The functions include determining, deciding, judging, calculating, computing, processing, deriving, investigating, looking up/searching/inquiring, ascertaining, receiving, transmitting, outputting, accessing, resolving, selecting, choosing, establishing, comparing, assuming, expecting, considering, broadcasting, notifying, communicating, forwarding, configuring, reconfiguring, allocating/mapping, assigning and the like, though not limited thereto. For example, the functional block (component part) that implements the function of transmitting is referred to as a transmitting unit or a transmitter. In any case, a means of implementation is not particularly limited as described above.

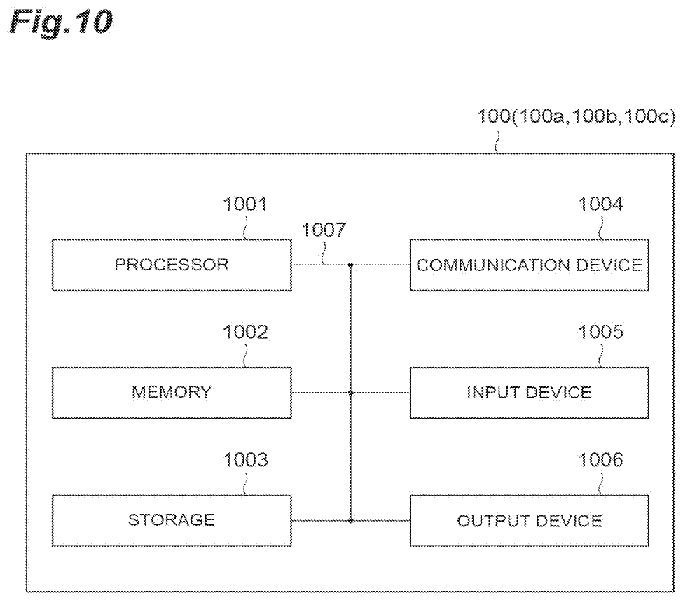

For example, the authorization server 100 according to one embodiment of the present disclosure may function as a computer that performs processing of an authorization method according to the present disclosure. FIG. 10 is a view showing an example of the hardware configuration of the authorization server 100 to the authorization server 100c according to one embodiment of the present disclosure. The authorization server 100 described above may be physically configured as a computer device that includes a processor 1001, a memory 1002, a storage 1003, a communication device 1004, an input device 1005, an output device 1006, a bus 1007 and the like.

In the following description, the term “device” may be replaced with a circuit, a device, a unit, or the like. The hardware configuration of the authorization server 100 may be configured to include one or a plurality of the devices shown in the drawings or may be configured without including some of those devices.

The functions of the authorization server 100 may be implemented by loading predetermined software (programs) on hardware such as the processor 1001 and the memory 1002, so that the processor 1001 performs computations to control communications by the communication device 1004 and control at least one of reading and writing of data in the memory 1002 and the storage 1003.

The processor 1001 may, for example, operate an operating system to control the entire computer. The processor 1001 may be configured to include a CPU (Central Processing Unit) including an interface with a peripheral device, a control device, an arithmetic device, a register and the like. For example, the location based authorization determination unit 102 and the like described above may be implemented by the processor 1001.

Further, the processor 1001 loads a program (program code), a software module and data from at least one of the storage 1003 and the communication device 1004 into the memory 1002 and performs various processing according to them. As the program, a program that causes a computer to execute at least some of the operations described in the above embodiments is used. For example, the location based authorization determination unit 102 may be implemented by a control program that is stored in the memory 1002 and operates on the processor 1001, and the other functional blocks may be implemented in the same way. Although the above-described processing is executed by one processor 1001 in the above description, the processing may be executed simultaneously or sequentially by two or more processors 1001. The processor 1001 may be implemented in one or more chips. Note that the program may be transmitted from a network through a telecommunications line.

The memory 1002 is a computer-readable recording medium, and it may be composed of at least one of ROM (Read Only Memory), EPROM (Erasable Programmable ROM), EEPROM (Electrically Erasable Programmable ROM), RAM (Random Access Memory) and the like, for example. The memory 1002 may be also called a register, a cache, a main memory (main storage device) or the like. The memory 1002 can store a program (program code), a software module and the like that can be executed for implementing an authorization method according to one embodiment of the present disclosure.

The storage 1003 is a computer-readable recording medium, and it may be composed of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, a magnetic strip and the like, for example. The storage 1003 may be called an auxiliary storage device. The above-described storage medium may be a database, a server, or another appropriate medium including the memory 1002 and/or the storage 1003, for example.

The communication device 1004 is hardware (a transmitting and receiving device) for performing communication between computers via at least one of a wired network and a wireless network, and it may also be referred to as a network device, a network controller, a network card, a communication module, or the like. The communication device 1004 may include a high-frequency switch, a duplexer, a filter, a frequency synthesizer or the like in order to implement at least one of FDD (Frequency Division Duplex) and TDD (Time Division Duplex), for example. For example, the above-described authorization control unit 101 may be implemented by the communication device 1004. The authorization control unit 101 may be implemented in a physically or logically separating the transmitting unit and the receiving unit.

The input device 1005 is an input device (e.g., a keyboard, a mouse, a microphone, a switch, a button, a sensor, etc.) that receives an input from the outside. The output device 1006 is an output device (e.g., a display, a speaker, an LED lamp, etc.) that makes output to the outside. Note that the input device 1005 and the output device 1006 may be integrated (e.g., a touch panel).

In addition, the devices such as the processor 1001 and the memory 1002 are connected by the bus 1007 for communicating information. The bus 1007 may be a single bus or may be composed of different buses between different devices.

Further, the authorization server 100 may include hardware such as a microprocessor, a DSP (Digital Signal Processor), an ASIC (Application Specific Integrated Circuit), a PLD (Programmable Logic Device), and an FPGA (Field Programmable Gate Array), and some or all of the functional blocks may be implemented by the above-described hardware components. For example, the processor 1001 may be implemented with at least one of these hardware components.

Notification of information may be made by another method, not limited to the aspects/embodiments described in the present disclosure. For example, notification of information may be made by physical layer signaling (e.g., DCI (Downlink Control Information), UCI (Uplink Control Information)), upper layer signaling (e.g., RRC (Radio Resource Control) signaling, MAC (Medium Access Control) signaling, annunciation information (MIB (Master Information Block), SIB (System information Block))), another signal, or a combination of them. Further, RRC signaling may be called an RRC message, and it may be an RRC Connection Setup mess age, an RRC Connection Reconfiguration message or the like, for example.

Further, each of the aspects/embodiments described in the present disclosure may be applied to at least one of a system using LTE (Long Term Evolution), LTE-A (LTE Advanced), SUPER 3G, IMT-Advanced, 4G (4th generation mobile communication system), 5G (5th generation mobile communication system), FRA (Future Radio Access), NR (new Radio), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra Wide Band), Bluetooth (registered trademark), or another appropriate system and a next generation system extended on the basis of these systems. Further, a plurality of systems may be combined (e.g., a combination of at least one of LTE and LTE-A, and 5G) for application.

The procedure, the sequence, the flowchart and the like in each of the aspects/embodiments described in the present disclosure may be in a different order unless inconsistency arises. For example, for the method described in the present disclosure, elements of various steps are described in an exemplified order, and it is not limited to the specific order described above.

Input/output information or the like may be stored in a specific location (e.g., memory) or managed in a management table. Further, input/output information or the like can be overwritten or updated, or additional data can be written. Output information or the like may be deleted. Input information or the like may be transmitted to another device.

The determination may be made by a value represented by one bit (0 or 1), by a truth-value (Boolean: true or false), or by numerical comparison (e.g., comparison with a specified value).

Each of the aspects/embodiments described in the present disclosure may be used alone, may be used in combination, or may be used by being switched according to the execution. Further, a notification of specified information (e.g., a notification of “being X”) is not limited to be made explicitly, and it may be made implicitly (e.g., a notification of the specified information is not made).

Although the present disclosure is described in detail above, it is apparent to those skilled in the art that the present disclosure is not restricted to the embodiments described in this disclosure. The present disclosure can be implemented as a modified and changed form without deviating from the spirit and scope of the present disclosure defined by the appended claims. Accordingly, the description of the present disclosure is given merely by way of illustration and does not have any restrictive meaning to the present disclosure.

Software may be called any of software, firmware, middle ware, microcode, hardware description language or another name, and it should be interpreted widely so as to mean an instruction, an instruction set, a code, a code segment, a program code, a program, a sub-program, a software module, an application, a software application, a software package, a routine, a sub-routine, an object, an executable file, a thread of execution, a procedure, a function and the like.

Further, software, instructions and the like may be transmitted and received via a transmission medium. For example, when software is transmitted from a website, a server or another remote source using at least one of wired technology (a coaxial cable, an optical fiber cable, a twisted pair and a digital subscriber line (DSL) etc.) and wireless technology (infrared rays, microwave etc.), at least one of those wired technology and wireless technology are included in the definition of the transmission medium.

The information, signals and the like described in the present disclosure may be represented by any of various different technologies. For example, data, an instruction, a command, information, a signal, a bit, a symbol, a chip and the like that can be referred to in the above description may be represented by a voltage, a current, an electromagnetic wave, a magnetic field or a magnetic particle, an optical field or a photon, or an arbitrary combination of them.

Note that the term described in the present disclosure and the term needed to understand the present disclosure may be replaced by a term having the same or similar meaning. For example, at least one of a channel and a symbol may be a signal (signaling). Further, a signal may be a message. Furthermore, a component carrier (CC) may be called a cell, a frequency carrier, or the like.

The terms “system” and “network” used in the present disclosure are used to be compatible with each other.

Further, information, a parameter and the like described in the present disclosure may be represented by an absolute value, a relative value to a specified value, or corresponding different information. For example, radio resources may be indicated by an index.

In the present disclosure, terms such as “base station (BS)”, “wireless base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, and “component carrier” are interchangeable. The base station is referred to by terms such as macrocell, small cell, femto cell, and picocell in some cases.

A base station can accommodate one or a plurality of (e.g., three) cells. In the case where a base station accommodates a plurality of cells, the whole coverage area of the base station can be partitioned into a plurality of smaller areas, and each of the smaller areas can provide a communication service by a base station sub-system (e.g., an indoor-type small base station RRH:Remote Radio Head). The term “cell” or “sector” indicates a part or the whole of a coverage area of at least one of a base station and a base station sub-system that perform a communication service in this coverage.

In the present disclosure, the terms such as “Mobile Station (MS)” “user terminal”, “User Equipment (UE)” and “terminal” can be used to be compatible with each other.

The mobile station can be also called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or several other appropriate terms.

At least one of the base station and the mobile station may be referred to by a transmitting device, a receiving device, a communication device and the like. Note that at least one of the base station and the mobile station may be a device mounted on a mobile unit, a mobile unit itself and the like. The mobile unit may be a vehicle (e.g., car, airplane, etc.), an unmanned mobile unit (e.g., drone, autonomous car, etc.), or a robot (manned or unmanned). Note that at least one of the base station and the mobile station includes a device that does not necessarily move during communication operation. For example, at least one of the base station and the mobile station may be IoT (Internet of Things) equipment such as a sensor.

Note that the term “determining” and “determining” used in the present disclosure includes a variety of operations. For example, “determining” and “determining” can include regarding the act of judging, calculating, computing, processing, deriving, investigating, looking up/searching/inquiring (e.g., looking up in a table, a database or another data structure), ascertaining or the like as being “determined” and “determined”. Further, “determining” and “determining” can include regarding the act of receiving (e.g., receiving information), transmitting (e.g., transmitting information), inputting, outputting, accessing (e.g., accessing data in a memory) or the like as being “determined” and “determined”. Further, “determining” and “determining” can include regarding the act of resolving, selecting, choosing, establishing, comparing or the like as being “determined” and “determined”. In other words, “determining” and “determining” can include regarding a certain operation as being “determined” and “determined”. Further, “determining (determining)” may be replaced with “assuming”, “expecting”, “considering” and the like.

The term “connected”, “coupled” or every transformation of this term means every direct or indirect connection or coupling between two or more elements, and it includes the case where there are one or more intermediate elements between two elements that are “connected” or “coupled” to each other. The coupling or connection between elements may be physical, logical, or a combination of them. For example, “connect” may be replaced with “access”. When used in the present disclosure, it is considered that two elements are “connected” or “coupled” to each other by using at least one of one or more electric wires, cables, and printed electric connections and, as several non-definitive and non-comprehensive examples, by using electromagnetic energy such as electromagnetic energy having a wavelength of a radio frequency region, a microwave region and an optical (both visible and invisible) region.

The description “on the basis of” used in the present disclosure does not mean “only on the basis of” unless otherwise noted. In other words, the description “on the basis of” means both of “only on the basis of” and “at least on the basis of”.

Furthermore, “means” in the configuration of each device described above may be replaced by “unit”, “circuit”, “device” or the like.

As long as “include”, “including” and transformation of them are used in the present disclosure, those terms are intended to be comprehensive like the term “comprising”. Further, the term “or” used in the present disclosure is intended not to be exclusive OR.

In the present disclosure, when articles, such as “a”, “an”, and “the” in English, for example, are added by translation, the present disclosure may include that nouns following such articles are plural.

In the present disclosure, the term “A and B are different” may mean that “A and B are different from each other”. Note that this term may mean that “A and B are different from C”. The terms such as “separated” and “coupled” may be also interpreted in the same manner.

### REFERENCE SIGNS LIST

100 . . . authorization server, 100a . . . authorization server, 100b . . . authorization server, 100c . . . authorization server, 101 . . . authorization control unit, 102 . . . location based authorization determination unit, 103 . . . affiliated store information DB, 104 . . . customer information DB, 105 . . . location feature value creation unit, 106 . . . location feature value DB, 107 . . . authorization comprehensive determination unit, 108 . . . base station information DB, 108a . . . base station information DB, 200 . . . affiliated store, 300 . . . communication terminal, 400 . . . location information DB

1. An authorization device comprising:
a customer information storage unit configured to store a payment means and a user terminal in association with each other;
a determination unit configured to determine legitimacy of a payment with the payment means on the basis of whether a location relationship between location information based on location registration of the user terminal when the payment with the payment means is made and a store where the payment with the payment means is made satisfies a predetermined condition or not; and
an output unit configured to output a determination result about legitimacy of the payment.

2. The authorization device according to claim 1, wherein when a distance based on the location relationship is within a predetermined distance, the determination unit determines that a payment with the payment means is legitimate, and when a distance based on the location relationship is not within a predetermined distance, the determination unit determines that a payment with the payment means is not legitimate.

3. The authorization device according to claim 1, wherein the determination unit calculates probability indicating legitimacy of a payment on the basis of the location relationship, and determines legitimacy of the payment on the basis of the probability.

4. The authorization device according to claim 1, further comprising:
a terminal feature value generation unit configured to generate a location feature value from past location information of the user terminal, wherein
the determination unit determines legitimacy of a payment with the payment means by using the location feature value.

5. The authorization device according to claim 1, further comprising:
a store feature value generation unit configured to generate a location feature value from location information of the store, wherein
the determination unit determines legitimacy of a payment with the payment means by using the location feature value.

6. The authorization device according to claim 1, wherein the determination unit determines whether a predetermined condition is satisfied or not on the basis of a relationship between a distance between a location based on location information of the user terminal and a location of the store and a threshold.

7. The authorization device according to claim 6, wherein the threshold is set according to characteristics of an area covered by a base station with which the user terminal has made location registration.

8. The authorization device according to claim 1, wherein the determination unit determines whether a payment with the payment means is legitimate or not on the basis of whether the store is located in an area set according to a base station with which the user terminal has made location registration.

9. The authorization device according to claim 8, wherein the area is set according to characteristics of a sector defined by the base station.

10. The authorization device according to claim 1, further comprising:
an affiliated store information storage unit configured to store location information of a store; and
a base station information storage unit configured to store location information based on a base station, wherein
the determination unit determines legitimacy of a payment with the payment means by referring to the affiliated store information storage unit, the base station information storage unit, and the customer information storage unit.

11. The authorization device according to claim 2, wherein the determination unit calculates probability indicating legitimacy of a payment on the basis of the location relationship, and determines legitimacy of the payment on the basis of the probability.

12. The authorization device according to claim 2, further comprising:
a terminal feature value generation unit configured to generate a location feature value from past location information of the user terminal, wherein
the determination unit determines legitimacy of a payment with the payment means by using the location feature value.

13. The authorization device according to claim 2, further comprising:
a store feature value generation unit configured to generate a location feature value from location information of the store, wherein
the determination unit determines legitimacy of a payment with the payment means by using the location feature value.

14. The authorization device according to of claim 2, wherein the determination unit determines whether a predetermined condition is satisfied or not on the basis of a relationship between a distance between a location based on location information of the user terminal and a location of the store and a threshold.

15. The authorization device according to claim 2, wherein the determination unit determines whether a payment with the payment means is legitimate or not on the basis of whether the store is located in an area set according to a base station with which the user terminal has made location registration.

16. The authorization device according to claim 6, wherein the determination unit determines whether a payment with the payment means is legitimate or not on the basis of whether the store is located in an area set according to a base station with which the user terminal has made location registration.

17. The authorization device according to claim 2, further comprising:
an affiliated store information storage unit configured to store location information of a store; and
a base station information storage unit configured to store location information based on a base station, wherein
the determination unit determines legitimacy of a payment with the payment means by referring to the affiliated store information storage unit, the base station information storage unit, and the customer information storage unit.

18. The authorization device according to claim 7, further comprising:
an affiliated store information storage unit configured to store location information of a store; and
a base station information storage unit configured to store location information based on a base station, wherein
the determination unit determines legitimacy of a payment with the payment means by referring to the affiliated store information storage unit, the base station information storage unit, and the customer information storage unit.

19. The authorization device according to claim 9, further comprising:
an affiliated store information storage unit configured to store location information of a store; and
a base station information storage unit configured to store location information based on a base station, wherein
the determination unit determines legitimacy of a payment with the payment means by referring to the affiliated store information storage unit, the base station information storage unit, and the customer information storage unit.
